(19) United States
(12) Patent Application Publication
(10) Pub. No.: US 2006/0079218 A1
(43) Pub. Date: Apr. 13, 2006

(54) Filtered wireless communications

(75) Inventors: Michael Aldridge, Chicago, IL (US); Fabrice Bonvoisin, Chicago, IL (US)

Correspondence Address: Paul E. Schaafsma;NovusIP, LLC, Suite 221, 521 West Superior, Chicago, IL, 60610, US

(73) Assignee: Tylu Wireless Technology, Inc.

(21) Appl. No.: 10/963,675

(22) Filed: Oct. 13, 2004

(51) Int. Cl. H04Q 7/20

(52) U.S. Cl. 455/422.1

(57) ABSTRACT

A method and apparatus for filtered wireless communications is provided. The method provides a managed wireless zone. A wireless zone communication system is provided having one or more wireless nodes. The wireless node can be a cellular base substation including a power source, a processor having software stored in memory, a transceiver designed to function solely in a filtered zone and to communicate with one or more wireless devices via an antenna transmitter, and a cellular phone number assigned to the cellular base substation. Wireless communication signals to be used within the managed wireless zone are registered. Subscriber are provided with filtering options, such as for example, allowing an identified wireless communication signal to receive in-coming calls within the filtered area, allowing an identified wireless communication signal to receive in-coming calls within the filtered area according to a schedule, forwarding an identified wireless communication signal to a destination number, forwarding an identified wireless communication signal to phone mail, switching an identified wireless communication signal from “ring” to vibrate and notifying an identified wireless communication signal regarding the managed wireless zone. Wireless communication signals are detected and identified within the wireless zone communication system. The identified wireless communication signals are compared with the filtering options.

### FIELD OF THE INVENTION

The invention relates generally to the field of telecommunications, and more specifically to the field of wireless communication, for example, cellular telephones.

### BACKGROUND OF THE INVENTION

The present invention pertains in general to the planning and deployment of cells in a cellular telephone network, and more particularly, to filtering the operation of cellular telephones in well delineated geographical areas. While the embodiment described herein is directed to cellular phones, the principles of the present invention apply to all types of wireless communication devices such as cellular phones, personal digital assistants, beepers, pagers, portable computers, and other wireless communication devices.

Today mobile telephones are becoming more and more frequent. The use of mobile telephones has in many regards facilitated the daily life for many people. For instance, cellular phones offer convenience in personal relationships and business dealings, by allowing users to stay in communication with the world in practically any public location. However, one person's convenience can be another person's annoyance.

However, in some places the use of mobile telephones is not appreciated and in some places even prohibited. Often, cellular phones ring and phone conversations occur, in some of the most inappropriate locations. For example, the peaceful enjoyment of a movie, play, or musical performance can be destroyed by the “ringing” of cellular phones in the audience. The concentration of students taking an exam or listening to a lecture can be broken by a cellular phone's ringing, or by another student's engagement in a conversation on a cellular phone. Also, a cellular phone can be disturbing to the public, and embarrassing to the cellular phone's owner, during church services, dining at a restaurant, or during quiet times observed in public, such as opening prays, the Pledge of Allegiance, and the National Anthem. The same applies to other locations such as for example, courtrooms, libraries, meeting rooms, conference rooms or any other location that radio frequency transmissions might be disruptive to persons or equipment in the vicinity.

Often certain locations have restrictions, rules or laws forbidding the operation of cellular phones. For example, hospitals attempt to prohibit use of cellular telephones because of the risk that the transmissions from the cellular telephone will interfere with the electronic medical equipment. Also, the use of cellular telephones is currently prohibited in an airplane while the airplane is preparing for take-off since transmissions from the cellular telephone can interfere with the operation of the airplane. Although cellular telephone network providers can attempt to locate cell sites away from prohibited locations such as airport runways, it is unlikely that cellular telephone service can be excluded from the geographical location of the airport runway while at the same time providing service to geographical areas adjacent to the runway

Also, some schools forbid students to use cellular phones or beepers on school grounds, in order to reduce the likelihood of drug trafficking and gang activity. Further, many commercial and governmental establishments, such as theaters, libraries and courtrooms, seek to restrict the use of cellular phones, beepers, and other types of wireless communication devices in order to avoid disruptions.

Therefore, there is a perceived need for a mobile telephone system that minimizes or completely removes the possibility to use a mobile telephone in certain restricted areas.

In order to solve this problem a number of different solutions have been proposed. In one approach, the goal is to eliminate the disturbance caused by a mobile station located in a certain area. One type of such approach simply eliminates or “blocks” signals in a given area by, for example, generating and radiating a magnetic field pattern, which includes a command signal, which commands a transmission interruption to a radio communication terminal. Another type of such system provides the mobile station with a control, which mutes the mobile station upon receiving a particular message transmitted from a transmitting station provided in the certain area.

In another approach, the goal is to notify the user of the restricted area. Thus, in one type of such approach a base station in a mobile telecommunication network is provided with a message transmission function that is installed near the place where use of a mobile telephone is restricted. When a mobile unit enters the area managed by the base station having the message transmission function, a message is transmitted from the base station to the mobile unit instructing the mobile unit to turn off a power supply for the mobile unit.

While the use of these “blocking” systems has gained support in certain jurisdictions, such blocking systems cannot be utilized in the United States. This is because cell-phone jamming runs afoul of the Federal Communications Commission, whose approval is required for devices that send signals over the air. In particular, the operation of transmitters designed to jam or block wireless communications is a violation of the Communications Act of 1934 (“Act”). See 47 U.S.C. § 301, 302a, 333. The Act prohibits any person from willfully or maliciously interfering with the radio communications of any station licensed or authorized under the Act or operated by the U.S. government. 47 U.S.C. § 333. The manufacture, importation, sale or offer for sale, including advertising, of devices designed to block or jam wireless transmissions is prohibited. 47 U.S.C. § 302a(b). Parties in violation of these provisions may be subject to the penalties set out in 47 U.S.C. § 501-510. Fines for a first offense can range as high as $11,000 for each violation or imprisonment for up to one year, and the device used may also be seized and forfeited to the U.S. government.

Likewise, certain jurisdictions outside the United State prohibit use of blocking systems. Moreover, even where blocking is permitted, it would still be advantageous to allow certain user and/or certain types of phone calls to be placed even when within the blocked area

### SUMMARY OF THE INVENTION

A method and apparatus for filtered wireless communications is provided. The method provides a managed wireless zone. A wireless zone communication system is provided having one or more wireless nodes. The wireless node can be a cellular base substation including a power source, a processor having software stored in memory, a transceiver designed to function solely in a filtered zone and to communicate with one or more wireless devices via an antenna transmitter, and a cellular phone number assigned to the cellular base substation. Wireless communication signals to be used within the managed wireless zone are registered. Subscriber are provided with filtering options, such as for example, allowing an identified wireless communication signal to receive in-coming calls within the filtered area, allowing an identified wireless communication signal to receive in-coming calls within the filtered area according to a schedule, forwarding an identified wireless communication signal to a destination number, forwarding an identified wireless communication signal to phone mail, switching an identified wireless communication signal from “ring” to vibrate and notifying an identified wireless communication signal regarding the managed wireless zone. Wireless communication signals are detected and identified within the wireless zone communication system. The identified wireless communication signals are compared with the filtering options.

### BRIEF DESCRIPTION OF THE DRAWINGS

FIG. 1 shows an overview of a system in accordance with the principles of the present invention.

FIG. 2 shows a schematic of a cellular base substation in accordance with the principles of the present invention.

FIG. 3 shows customer access their account on the central server via the wide area network.

FIG. 4 shows an additional embodiment of the present invention.

### DETAILED DESCRIPTION OF AN EMBODIMENT OF THE INVENTION

In the planning and deployment of a cellular telephone network, the geographical service area to be covered by the cellular telephone network is partitioned into a plurality of cells. While in operation, a cellular telephone continually compares received signal strengths from base stations in cells adjacent to the cellular telephone. Typically, the cellular telephone establishes communication with the base station having the strongest signal. As the cellular telephone moves about the service area. Signal strengths from the base stations vary and eventually the cellular telephone reselects a new base station or, if on call, is handed-off from the current base station servicing the cellular telephone to a base station now having a stronger signal.

Conventionally, when a power ON operation is carried out for the portable telephone set within a service area, a position registration process of the telephone set is performed for a database used for position management and located in the network. In other words, a position registration request is made from the portable telephone set to a position management server via a public base station, and the position registration server informs, after its registration, the portable telephone set of its position registration reception.

Cellular units are directed or “listen” automatically to predetermined control frequencies, while they are in the standby mode. The control is two-way full duplex, such that there are a plurality of forward control channels (FCC) from the cell to the portable unit (uplink), and a plurality of reverse control channels (RCC) from the telephone to the cell (downlink). A maximum of three channels are assigned to each cell or sector. The cellular units automatically adjust to the best of these channels available in the cell or sector.

In one of two possibilities in establishing a cellular conversation, the subscriber initiates a conversation from the cellular unit to any telephone subscriber. In this case, the destination subscriber number is dialed and the send button is pressed, and this begins a handshake routine opposite the local cellular cell, which provides service in a given area. The call handling is then passed to an area cellular mobile telephone switch office (MTSO), which checks the information, performs a verification that the subscriber is operating properly, and is entitled to receive service and then connects to the destination subscriber. This process is known as “call setup”.

In the second possibility, the cellular system receives a request to establish a conversation with a cellular subscriber, and the area cellular MTSO performs a subscriber locate/search activity by sending a “search call” to all the cellular cells (connected to it) and these broadcast it on their control frequencies. The destination subscribers (when in a standby mode) which are tuned to the local control frequency, respond to the search call and this begins a handshake routine with the area cellular MTSO. When finished, the system assigns a pair of specific frequencies, a forward control channel (FCC) from the cell to the portable unit, and a reverse control channel (RCC) from the telephone to the cell, in full duplex mode, to which the telephone and cell are tuned. Only after this, a ring command is broadcast to the telephone, activating the cellular subscriber's ringing unit, and this clears the way for a full conversation.

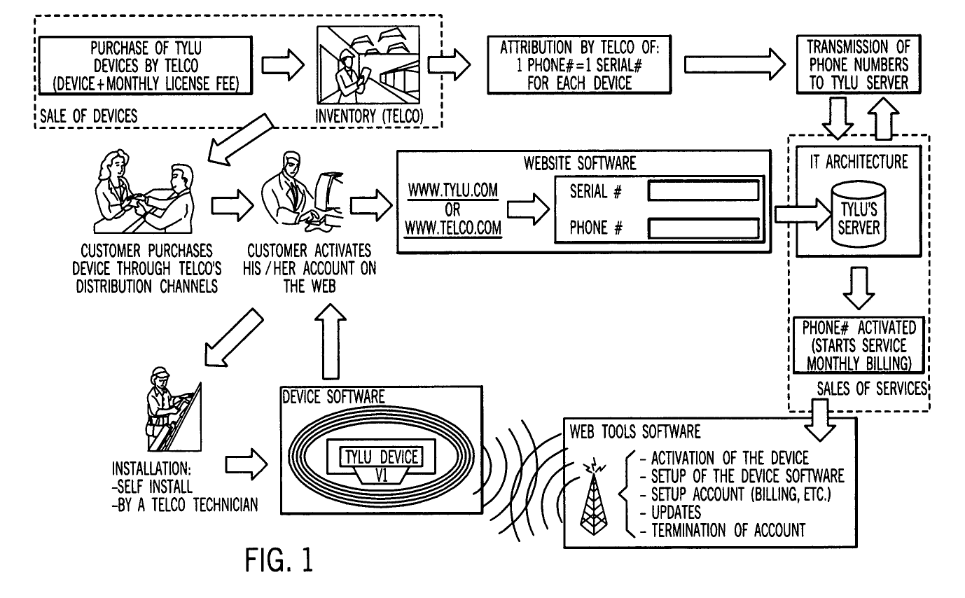

Referring to FIG. 1, an overview of a system in accordance with the principles of the present invention is seen. Importantly, the system of the present invention is provided by the cellular provider who thus is licensed or authorized by the Federal Communications Commission under the Act. The filtering of the present invention is provided by the cellular provider to those cellular users who receive their cellular services from that cellular provider; thus, a system in accordance with the principles of the present invention should not conflict with the Communications Act of 1934.

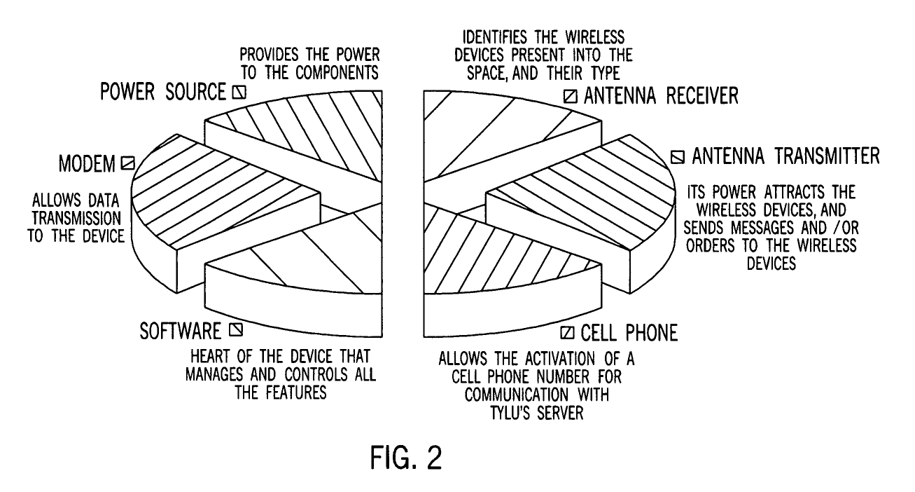

The filtering of the present invention can be provided by any number of wireless nodes referred to herein as a cellular base substation. The filtering of the present invention can be provided to a stationary indoor area, a stationary outdoor area or a mobile area such as for example trains, busses, airplanes, cars, etc. Referring to FIG. 2, a schematic of a cellular base substation is seen. The cellular base substation includes a power source such as hard wiring to a building electric power system or a battery. The cellular base substation includes at least one processor having software stored in memory. Memory includes control software, and can include, but is not limited to, random access memory (RAM), read only memory (ROM), flash memory, electrically erasable programmable ROM (EEPROM), and the like. Memory can contain stored instructions, tables, data, and the like, to be utilized by the processor(s). Memory contains and runs an operating system and applications to control and communicate with onboard peripherals.

The cellular base substation also includes a standard router/switcher and a transceiver. The transceiver is designed to function solely in the filtered zone and to communicate with one or more wireless devices via antenna. An example of a transceiver is a Bluetooth™ compatible transceiver. Bluetooth™ is a short-range wireless standard capable of forming personal wireless networks utilizing mobile, portable, wireless devices made in accordance with the standards promulgated by Bluetooth SIG, Inc., a Bluetooth Special Interest Group (SIG) trade association, Overland Park, Kans., USA. The invention is not limited to a Bluetooth™ compatible transceiver and can include any short-range wireless transceivers and protocols. Any number of wireless nodes can be deployed in the filtered zone in order to provide coverage for a portion or the entire zone.

The cellular base substation further includes a cellular telephone, including a cellular phone number as described below, that allows for communication with a central server. For example, a modem, preferably wireless, can be provided to accept and receive data transmissions such as, for example, software update downloads.

The cellular base substation further includes an antenna transmitter. The antenna transmitter sends messages and commands to the cellular device. After installation, when in the filtered area any cellular units serviced by the cellular provider will recognize the signal strength from the base substation as strongest and will therefore establish communication with the base substation. An antenna receiver is provided. The antenna receiver identifies the cellular devices present in the filtered space and receives signals from the cellular devices.

In one embodiment contemplated hereunder, the base substations are purchased by a cellular provider, who provides the base substation to subscribing customers, through the cellular provider's distribution channels. The cellular provider assigns a cellular phone number for the cellular base substation. The cellular phone number is provided to a central server for future use. A unique identification is then assigned to the base station and stored in the central processor.

Upon purchase of the cellular base substation, the base substation is installed in the area to be filtered, either by a cellular provider technician or by the user. The customer activates an account with the central server. In one embodiment, the customer activates their account by registering with the central server via a wide area network such as the Internet. In one embodiment, the customer registers via the cellular provider's website; in an alternative embodiment, the customer registers via the provider of the present invention.

Upon registration, the service of the present invention is activated. Via the central server, the phone number is activated and the device software is set-up, an account is set up for billing, etc.), updates are provided, and if requested, the account can be terminated. Activation of the device is based on the identification number and the phone number. The unique identifier (identification number and phone number) permits control over the devices that benefits the carriers and the users.

The database carries the current status of a device, such as account information, filtering options, etc. In addition, the database can provide the user with various options to manage the user's facility, such as for example, grouping multiple base substations in different categories so that different filtering options can be applied; for example, in a educational setting, classrooms, lecture halls, sports facilities, etc. can be grouped together with the user designating what filtering options apply to each such category.

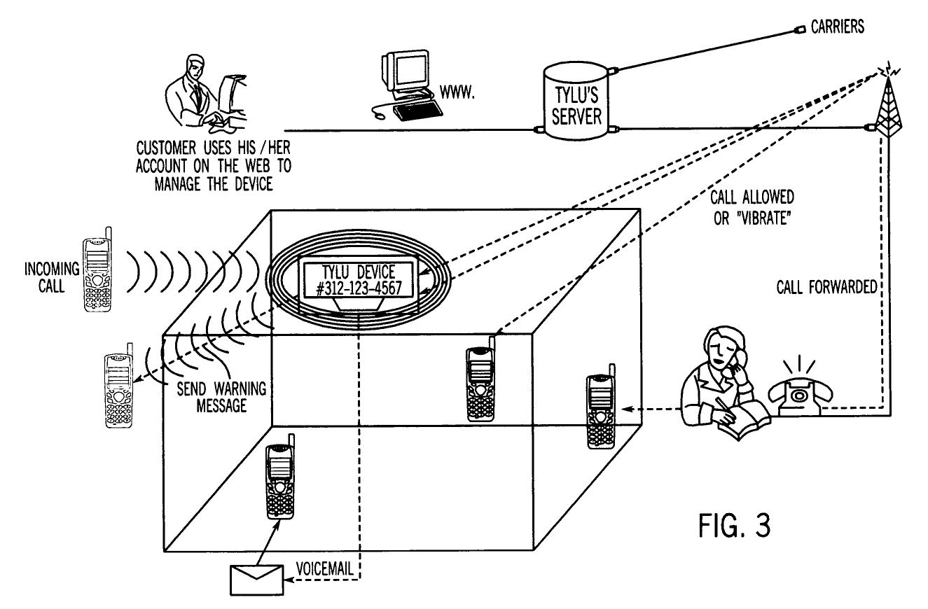

Referring to FIG. 3, following installation the customer can access their account on the central server via the wide area network. Via the central server and the software in the microcomputer in the base substation, the customer can choose various filtering options. For each customer, an administrator can be provided with a sub-account with identification and password. Authorized cell phone numbers can be registered. These cell phone numbers are allowed to receive in-coming calls within the filtered area. A simple table can be provided in which phone numbers are entered. If a phone number is validated, that number is allowed to receive in-coming calls.

In addition, alternative cell phone numbers can be registered for use of “call forward” feature. Choices can be provided such as by a table or a check box for example, where the owner of the device can activate the “call forward” and enter the destination number. In addition, a schedule for device deactivation can be provided. A timer can be used for the use of the device per month, week, day and hour. Options can include “Never”, “Always”, per month, per day, per week, etc. The timer provides the flexibility necessary to manage the time zones, and the seasons (winter/summer hours). The user can determine what features are affected by the timer. The timer can also be applied to grouped multiple base substations as additional filtering options.

Additional filtering options can include for example initiating a message to the cellular user upon entering the filtered area; initiating call forwarding of the cellular number to a forwarded number, such as for example a receptionist; initiating call forwarding of the cellular number to phone mail; switching the cellular telephone from “ring” to vibrate while within the filtered area; etc.

In additional embodiments of the present invention, a multi-device management system can be provided. A summary of all devices in the network with status indicator for each device can be provided. This summary could be organized by standard (for example, Frequency Division Multiple Access (FDMA), Time Division Multiple Access (TDMA), Code Division Multiple Access (CDMA), Global System for Mobile Communications (GSM), etc., and other wireless communication such as standard transmission control protocol/internet protocol (TCP/IP) equipment.), and the identification related to each device (for example, phone number, etc.). Groups of devices can be created to allow an administrator to choose to apply choices to one or all devices. Text can be created for messages to be sent to cell phones. The messages can be uniform or specific to each device.

In a further embodiment, the present invention can provide various security features where such security has been approved by the appropriate governing body. For example, the device can record all presence detected during a certain period of time. A log sheet could be provided for all cell phone numbers that came through the area. In addition, the device could records the caller identification of all calls received during a certain period of time. A log sheet could be provided for all cell phone numbers that came through the area. The device could identify the presence of a selected cell phone number in the area. The device could alert the user when the selected cell phones are within the area.

In a further embodiment, the present invention can provide military/intelligence applications. The principles of the present invention could be used to provide a record of calls in a managed area where enemies are using wireless communication. The intelligence could parachute the devices in a targeted area and listen to the conversations, including through satellite.

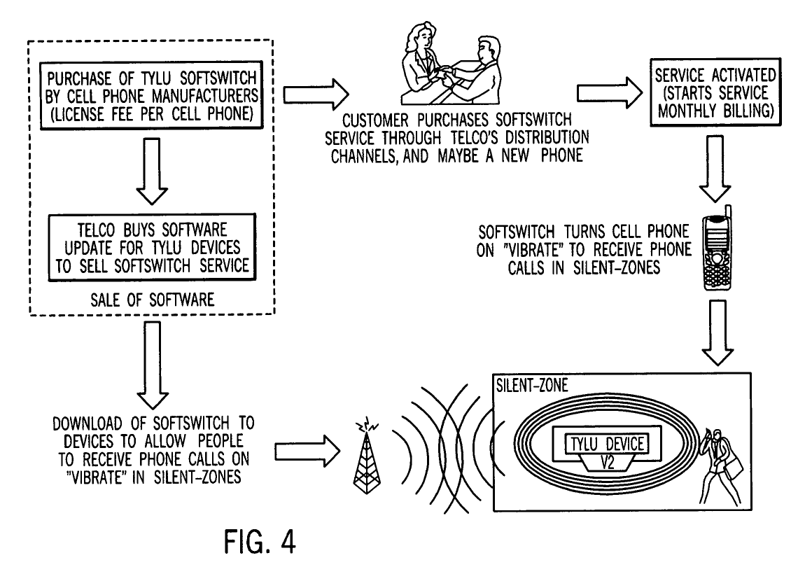

Referring now to FIG. 4, an additional embodiment of the present invention is seen. In this additional embodiment, an additional feature in the form of an automatic switch from cellular “ring” to a vibrate mode when in the filtered area is provided.

While the invention has been described with specific embodiments, other alternatives, modifications and variations will be apparent to those skilled in the art. All such alternatives, modifications and variations are intended to be included within the spirit and scope of the appended claims.

What is claimed is:

1. A method of wireless communication within a managed wireless zone comprising:
providing a wireless zone communication system having one or more wireless nodes;
registering wireless communication signals to be used within the managed wireless zone;
providing a subscriber with filtering options;
detecting and identifying wireless communication signals within the wireless zone communication system; and
comparing the identified wireless communication signals with the filtering options.

2. The method of controlling wireless communication activity of claim 1, wherein the wireless communication signals are Frequency Division Multiple Access (FDMA) signals.

3. The method of controlling wireless communication activity of claim 1, wherein the wireless communication signals are Time Division Multiple Access (TDMA) signals.

4. The method of controlling wireless communication activity of claim 1, wherein the wireless communication signals are Code Division Multiple Access (CDMA) signals.

5. The method of controlling wireless communication activity of claim 1, wherein the wireless communication signals are Global System for Mobile Communications (GSM) signals.

6. The method of controlling wireless communication activity of claim 1, wherein the wireless communication signals are transmission control protocol/internet protocol (TCP/IP) signals.

7. The method of controlling wireless communication activity of claim 1, wherein the filtering options comprise allowing an identified wireless communication signal to receive in-coming calls within the filtered area.

8. The method of controlling wireless communication activity of claim 7, wherein the filtering options comprise allowing an identified wireless communication signal to receive in-coming calls within the filtered area according to a schedule.

9. The method of controlling wireless communication activity of claim 1, wherein the filtering options comprise forwarding an identified wireless communication signal to a destination number.

10. The method of controlling wireless communication activity of claim 1, wherein the filtering options comprise forwarding an identified wireless communication signal to phone mail.

11. The method of controlling wireless communication activity of claim 1, wherein the filtering options comprise switching an identified wireless communication signal from “ring” to vibrate.

12. The method of controlling wireless communication activity of claim 1, wherein the filtering options comprise notifying an identified wireless communication signal regarding the managed wireless zone.

13. The method of controlling wireless communication activity of claim 1, wherein the managed wireless zone is stationary.

14. The method of controlling wireless communication activity of claim 13, wherein the managed wireless zone is outdoors.

15. The method of controlling wireless communication activity of claim 1, wherein the managed wireless zone is mobile.

16. A cellular base substation comprising:
a power source;
a processor having software stored in memory;
a transceiver designed to function solely in a filtered zone and to communicate with one or more wireless devices via an antenna transmitter; and
a cellular phone number assigned to the cellular base substation.

17. The cellular base substation of claim 16, wherein the wireless devices utilize Frequency Division Multiple Access (FDMA) signals.

18. The cellular base substation of claim 16, wherein the wireless devices utilize Time Division Multiple Access (TDMA) signals.

19. The cellular base substation of claim 16, wherein the wireless devices utilize Code Division Multiple Access (CDMA) signals.

20. The cellular base substation of claim 16, wherein the wireless devices utilize Global System for Mobile Communications (GSM) signals.

21. The cellular base substation of claim 16, wherein the wireless devices utilize transmission control protocovinternet protocol (TCP/IP) signals.

22. The cellular base substation claim 16, wherein the filtering zone comprises allowing an identified wireless communication signal to receive in-coming calls within the filtered zone.

23. The cellular base'substation of claim 22, wherein the filtering zone comprise allowing an identified wireless communication signal to receive in-coming calls within the filtered area according to a schedule.

24. The cellular base substation of claim 16, wherein the filtering zone comprise forwarding an identified wireless communication signal to a destination number.

25. The cellular base substation of claim 16, wherein the filtering zone comprise forwarding an identified wireless communication signal to phone mail.

26. The cellular base substation of claim 16, wherein the filtering zone comprise switching an identified wireless communication signal from “ring” to vibrate.

27. The cellular base substation of claim 16, wherein the filtering zone comprise notifying an identified wireless communication signal regarding the managed wireless zone.

28. The cellular base substation of claim 16, wherein the filtering zone is stationary.

29. The cellular base substation of claim 28, wherein the filtering zone is outdoors.

30. The cellular base substation of claim 16, wherein the filtering zone is mobile.
